(19) United States
(12) Patent Application Publication
(10) Pub. No.: US 2006/0087215 A1
(43) Pub. Date: Apr. 27, 2006

(54) Cathode ray tube

(75) Inventor: Tetsuya Masumura, Suita-shi (JP)

Correspondence Address: HAMRE, SCHUMANN, MUELLER & LARSON, P.C., P.O. BOX 2902-0902, MINNEAPOLIS, MN, 55402, US

(73) Assignee: Matsushita Toshiba Picture Display Co., Ltd., Takatsuki-shi (JP)

(21) Appl. No.: 11/141,376

(22) Filed: May 31, 2005

(30) Foreign Application Priority Data
Oct. 22, 2004 (JP) 2004-308574

(51) Int. Cl. H01J 29/86; H01J 29/92

(52) U.S. Cl. 313/477 R

(57) ABSTRACT

A mask main body 17 includes an effective surface 14 in which electron beam passage holes 13 are formed, and a hole-free portion 15 surrounding the effective surface 14. When we let Ry be the radius of curvature of a curve in the Y axis direction of the effective surface 14 of the mask main body 17, let Rx be the radius of curvature of a curve in the X axis direction, calculate the radius of curvature Rk of the curved surface on the effective surface 14 as Rk²=Rx×Ry, and let Rk(d) be the radius of curvature of the curved surface near the diagonal axis ends of the effective surface 14, Rk(h) be the radius of curvature of the curved surface near the X axis ends, and Rk(c) be the radius of curvature of the curved surface in the center portion, the following relations are satisfied: Rk(c)>Rk(h), Rk(c)>Rk(d), and −800 mm≦Rk(h)−Rk(d)≦800 mm.

### BACKGROUND OF THE INVENTION

1. Field of the Invention

The present invention relates to a cathode ray tube in which a shadow mask is used, and more particularly relates to a technique for raising the curved surface support strength of a shadow mask.

2. Description of Related Art

FIG. 10 is a cross-sectional view of an example of a conventional cathode ray tube. A cathode ray tube 1 comprises a vacuum envelope 2, various constituent parts attendant thereto, and a deflection apparatus 12 disposed surrounding the outer periphery of the vacuum envelope 2. The vacuum envelope 2 is formed by joining a funnel-shaped funnel 4 to a panel 3. The panel 3 comprises a side wall portion 3b around the periphery of an effective portion 3a formed in a curved surface, and the funnel 4 is joined to this side wall portion 3b. A fluorescent screen 5 is provided on the inner surface of the effective portion 3a of the panel 3. The fluorescent screen 5 is formed from a black non-light-emitting layer and a three-color light-emitting layer formed so as to be embedded in the gaps of this black non-light-emitting layer.

A substantially rectangular shadow mask 6 is disposed across from the fluorescent screen 5. An electron gun 10 is disposed inside a neck 8 of the funnel 4. The electron gun 10 emits three electron beams 9B, 9G, and 9R. These three electron beams 9B, 9G, and 9R are deflected by the deflection apparatus 12 and are horizontally and vertically scanned over the fluorescent screen 5 through the shadow mask 6, which results in the display of an image.

The shadow mask 6 is used to sort the three electron beams 9B, 9G, and 9R emitted from the electron gun 10 with respect to the three-color light-emitting layer constituting the fluorescent screen 5. The shadow mask 6 comprises a mask main body 17 attached to a mask frame 18. The mask main body 17 is formed in substantially rectangular shape by an effective surface in the form of a curved surface and across from the fluorescent screen 5 and in which numerous electron beam passage holes are formed, a hole-free portion surrounding the outer periphery of this effective surface, and a skirt produced by bending the hole-free portion at a substantially right angle over its entire periphery. The mask frame 18 is attached to the skirt of the mask main body 17.

As shown in FIG. 10, the shadow mask 6 is supported removably on the inside of the panel 3 by latching wedge-shaped elastic supports 20, which are attached to each of the corners of the mask frame 18, to stud pins 21 provided at the corners of the side wall portion 3b of the panel 3.

Since the path of an electron beam is affected by a magnetic field, an inner shield 22 that extends to the electron gun 10 side is attached to the mask frame 18 for blocking external magnetic fields.

Generally, to display an image with no color drift on the fluorescent screen 5 of the cathode ray tube, the three electron beams 9B, 9G, and 9R passing through the electron beam passage holes of the mask main body 17 must be sorted so that they land properly on the three-color light-emitting layer. To this end, the panel 3 and the shadow mask 6 must be in the correct positional relationship, and in particular the gap between the inner surface of the effective portion 3a of the panel 3 and the effective surface of the mask main body 17 must be within a specific permissible range.

In order to improve the visibility of cathode ray tubes, there has been a demand in recent years to increase the radius of curvature of the outer surface of the effective portion 3a of the panel 3 so as to make the surface flatter. FIG. 10 illustrates an example in which the outer surface of the effective portion 3a of the panel 3 is substantially flat.

With a panel 3 such as this, the radius of curvature of the inner surface of the effective portion 3a has to be increased for the sake of visibility and the air pressure resistance of the vacuum envelope, and as the radius of curvature of the inner surface of the effective portion 3a increases, the radius of curvature of the effective surface of the shadow mask 6 also has to be increased in order to obtain suitable beam landing.

However, when the radius of curvature of the effective surface of the shadow mask 6 is increased, the curved surface support strength decreases, making it more likely that thermal deformation will occur in the course of manufacturing the cathode ray tube, or that local deformation will occur in the course of manufacturing the shadow mask 6, and improper beam landing and color impurity are more apt to occur. JP-H7-161306A proposes a technique for solving these problems, in which the curved surface support strength of the shadow mask is increased by providing a reinforcing bead to the effective surface.

Nevertheless, when a reinforcing bead is provided for an effective surface with a large radius of curvature in an attempt to obtain adequate curved surface support strength, the gap between the effective surface of the shadow mask and the inner surface of the effective surface of the panel locally deviates from the permissible range, an image of the step formed by the provision of this reinforcing bead appears on the screen, and this markedly diminishes image quality. Consequently, the height of the reinforcing bead is usually limited to only about 0.2 mm, which in turn limits how much the curved surface support strength can be increased.

### SUMMARY OF THE INVENTION

The present invention is intended to solve these problems encountered in the past, and it is an object thereof to provide a cathode ray tube with which the curved surface support strength of the mask main body is increased, thereby reducing deviation in beam landing and preventing a decrease in color purity.

To achieve the stated object, the cathode ray tube of the present invention is a cathode ray tube comprising a panel on the inner surface of which a fluorescent screen is formed and the outer surface of which is substantially flat, and a substantially rectangular shadow mask disposed across from the fluorescent screen. The shadow mask comprises a substantially rectangular mask main body attached to a substantially rectangular mask frame, the mask main body includes an effective surface in which electron beam passage holes are formed, and a hole-free portion surrounding the effective surface. When the vertical axis is the axis in the screen vertical direction through which the tube axis of the cathode ray tube passes, and the horizontal axis be the axis in the screen horizontal direction through which the tube axis of the cathode ray tube passes, and when Ry is the radius of curvature of a curve in the vertical axis direction of the effective surface of the mask main body, Rx is the radius of curvature of a curve in the horizontal axis direction, and the square of the radius of curvature of the curved surface on the effective surface be Rk²=Rx×Ry, and when Rk(d) is the radius of curvature of the curved surface near the diagonal axis ends of the effective surface, Rk(h) is the radius of curvature of the curved surface near the horizontal axis ends, and Rk(c) is the radius of curvature of the curved surface in the center portion, the following relationships are satisfied: Rk(c)>Rk(h), Rk(c)>Rk(d), and −800 mm≦Rk(h)−Rk(d)≦800 mm.

### BRIEF DESCRIPTION OF THE DRAWINGS

FIG. 1 is a perspective view of the mask main body according to an embodiment of the present invention;

FIG. 2A is a plan view of the shadow mask according to an embodiment of the present invention;

FIG. 2B is a cross-sectional view along the A-A′ line in FIG. 2A;

FIG. 3 is a plan view of part of the shadow mask according to an embodiment of the present invention;

FIG. 4 is a graph of the relationship between the curved surface support strength of the shadow mask and the radius of curvature differential according to an embodiment of the present invention;

FIG. 5 is a graph of the relationship between the curved surface support strength of the shadow mask and the radius of curvature differential according to another embodiment of the present invention;

FIG. 6 is a table of the distribution of the radius of curvature of the effective surface according to an embodiment of the present invention;

FIG. 7 is a graph of the distribution of the radius of curvature of the effective surface of the shadow mask according to an embodiment of the present invention;

FIG. 8 is a table of the distribution of the radius of curvature of the effective surface according to another embodiment of the present invention;

FIG. 9 is a graph of the distribution of the radius of curvature of the effective surface of the shadow mask according to another embodiment of the present invention; and

FIG. 10 is a cross-sectional view of an example of a conventional cathode ray tube.

### DETAILED DESCRIPTION OF THE INVENTION

By satisfying the formulas of the present invention given above, it is possible to raise the curved surface support strength of the mask main body and thereby reduce deviation in beam landing and prevent a decrease in color purity.

In the present invention, it is preferable that a band-shaped range of the effective surface, with a width of 30 mm, having the horizontal axis as one of its sides, and extending from the horizontal axis ends to the tube axis side, includes a portion in which the radius of curvature distribution in the vertical axis direction of the effective surface becomes a concave radius of curvature distribution having a minimal value.

Also, it is preferable that a band-shaped range of the effective surface, with a width of 30 mm, having the horizontal axis as one of its sides, and extending from the horizontal axis ends to the tube axis side, includes a portion in which the radius of curvature distribution in the vertical axis direction of the effective surface becomes a convex radius of curvature distribution having a maximal value.

Also, it is preferable that, in the band-shaped range of the effective surface with a width of 30 mm, having the horizontal axis as one of its sides, and extending from the horizontal axis ends to the tube axis side, the absolute value of the difference between the largest value and the smallest value of the radius of curvature of the effective surface is 3000 mm or less.

With the preferred cathode ray tubes of the present invention given above, the curved surface support strength of the mask main body can be increased further.

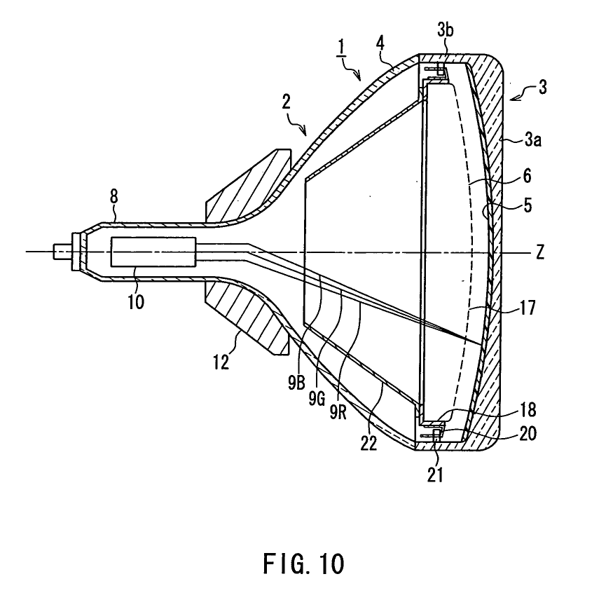

An embodiment of the present invention now will be described with reference to the drawings. The basic structure of the cathode ray tube in this embodiment is generally the same as that of the cathode ray tube shown in FIG. 10, and therefore only the shadow mask will be described in detail in this embodiment.

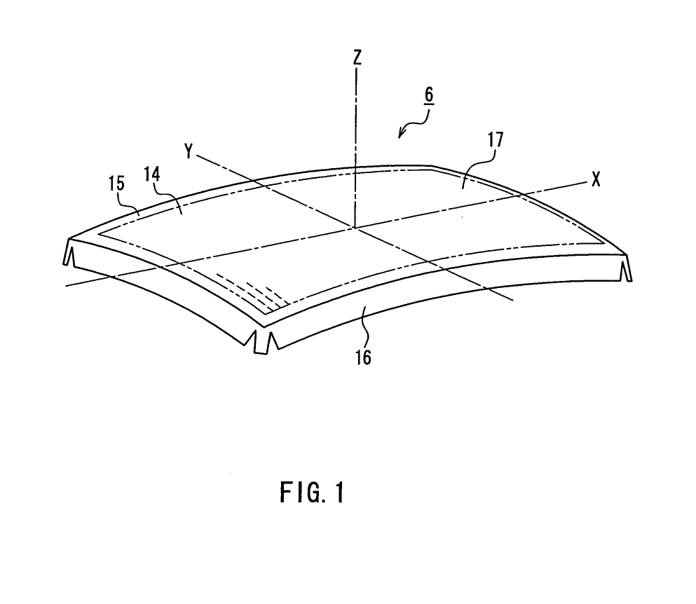

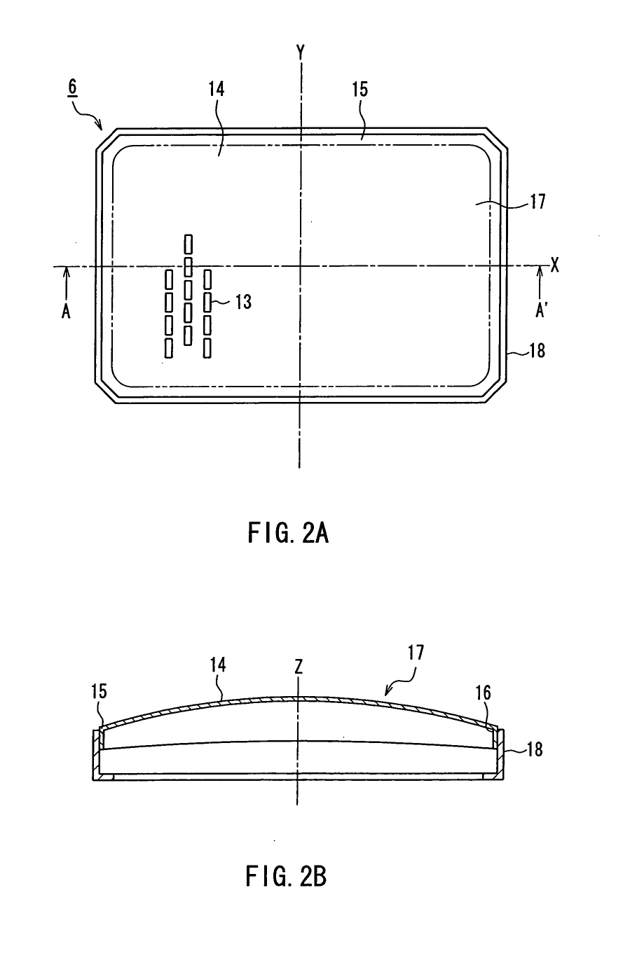

FIG. 1 is a perspective view of the mask main body of the shadow mask according to an embodiment of the present invention. FIG. 2A is a plan view of the shadow mask according to an embodiment of the present invention. FIG. 2B is a cross-sectional view along the A-A′ line in FIG. 2A. As described regarding FIG. 10, the shadow mask is an electrode that performs color sorting on three electron beams corresponding to the colors red (R), green (G), and blue (B) emitted from the electron gun 10.

In FIG. 1, the Z axis is the tube axis of the cathode ray tube, the Y axis is a screen vertical direction axis and passes through the tube axis of the cathode ray tube, and the X axis is a screen horizontal direction axis and passes through the tube axis of the cathode ray tube. This is all the same as described below.

The mask main body 17 of the shadow mask 6, when viewed in the Z axis direction, has the effective surface 14 and the hole-free portion 15 that extends around the periphery of the effective surface 14. Numerous slotted or dotted electron beam passage holes are formed in the effective surface 14. A skirt 16 is formed by bending the hole-free portion 15 at a substantially right angle over its entire periphery toward the electron gun 10.

The effective surface 14 and the hole-free portion 15, when viewed in the Z axis direction, is formed in a substantially rectangular shape as shown in FIG. 2A, and has a gently sloping dome-shaped curved surface formed as shown in FIG. 2B. Also, as shown in FIG. 2B, the mask main body 17 is supported and fixed to the rectangular mask frame 18 via the skirt 16.

In order to improve the visibility of cathode ray tubes, there has been a demand in recent years to increase the radius of curvature of the outer surface of the effective portion of the panel so as to make the surface flatter. The panel according to this embodiment is premised on the outer surface of the effective portion of the panel being substantially flat, that is, the radius of curvature of the outer surface of the effective portion of the panel being at least 10,000 mm.

With a panel such as this, the radius of curvature of the inner surface of the effective portion has to be increased for the sake of visibility and the air pressure resistance of the vacuum envelope, and as the radius of curvature of the inner surface of the effective portion increases, the radius of curvature of the effective surface 14 of the mask main body 17 also has to be increased in order to obtain suitable beam landing.

In general, the curved surface support strength decreases when the radius of curvature of the effective surface 14 of the mask main body 17 is increased. As a result, it is more likely that local deformation will occur in the course of manufacturing the mask main body 17, and even after completion of manufacture, deformation is apt to occur under impact. When the mask main body 17 is deformed, improper beam landing and color impurity are likely to occur.

When a cathode ray tube is subjected to an impact, the inertial force to which the shadow mask is subjected increases in proportion to the weight of the mask main body 17 from the portion where the inertial force is applied to the center of the mask main body 17, or in other words, to the surface area of the mask main body 17. In this case, the weight of the entire surface of the effective surface 14 results in more inertial force being imparted near the periphery of the effective surface 14 than in the area near the center. Furthermore, inertial force concentrates near the periphery of the effective surface 14 as a result of the difference in mechanical strength of the materials of the effective surface 14 and the hole-free portion 15, which also tends to result in deformation.

Meanwhile, the curved surface support strength versus the inertial force of the effective surface 14 increases in inverse proportion to the radius of curvature. Therefore, it is usually necessary for the radius of curvature near the periphery of the effective surface 14 to be lower than in the center. With the present invention, as will be described in specific terms below, in order to increase curved surface support strength, the inventors focused on the radius of curvature distribution on the short sides (the sides in the Y axis direction) near the periphery of the effective surface 14, rather than merely reducing the overall radius of curvature.

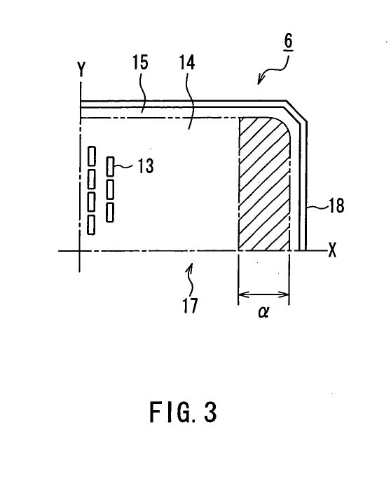

FIG. 3 is a diagram illustrating the region of specified radius of curvature in the curved surface of the effective surface 14 of the mask main body 17 in the present invention. This diagram only shows part of the mask main body 17, but the mask main body 17 is symmetrical on either side of the X and Y axes.

The mask main body 17 here generally is formed as a dome-shaped curved surface by press forming a mask in which holes have been formed. Because of variances between press machines and so forth, the actual curved surface may differ slightly from an ideal curved surface. To confirm this, displacement in the Z axis direction (hereinafter referred to as “sink”) between the center of the mask main body and a measurement point is measured at numerous points, and how much difference there is from an ideal curved surface is calculated. At the same time, it is determined how much the radius of curvature of curves in the vertical and horizontal directions differs from the ideal state.

However, it is difficult to identify the intrinsic radius of curvature distribution of a curved surface from the radius of curvature of a curved line alone, and no causal link could be found between the mask curved surface support strength and the radius of curvature distribution of the effective surface of the shadow mask.

The most common way of expressing the radius of curvature of a curved surface is called total curvature or Gauss curvature. In this case, the total curvature K is expressed by the following formula (1).
K=1/(R1/R2) Formula 1

In Formula 1, the radii of curvature R1 and R2 are the maximal and minimal values in an infinite number of normal cross sections with respect to a point on the curved surface.

However, measuring an infinite number of points on a mask curved surface is difficult, both in terms of measurement volume and measurement time.

In view of this, in this embodiment the maximal and minimal values are assumed for the sake of convenience to be the radius of curvature Rx of a curve in the horizontal direction and the radius of curvature Ry of a curve in the vertical direction, the radius of curvature Rk of the curved surface of the effective surface 14 is ascertained, and the following formula 2 is used.
Rk²=Rx×Ry Formula 2

Using Formula 2 allows the radius of curvature distribution of a curved surface to be confirmed more efficiently, and the radius of curvature distribution of a curved surface at which the curved surface support strength can be increased can be derived easily.

This will be described in detail below, but experimental confirmation was repeated, and it was found that the curved surface support strength of a shadow mask can be improved by satisfying the following formulas (3, 4, and 5).
Rk(c)>Rk(h), Formula 3
Rk(c)>Rk(d), and Formula 4
−800≦Rk(h)−Rk(d)≦800 Formula 5

In these formulas, Rk(c) is the radius of curvature (mm) of the curved surface at the center portion of the effective surface 14, Rk(d) is the radius of curvature (mm) of the curved surface near the diagonal ends of the effective surface 14, and Rk(h) is the radius of curvature (mm) of the curved surface near the horizontal axis ends.

The “center portion” here is a square region measuring 30 mm in the positive direction of the Y axis and 30 mm in the positive direction of the X axis from the origin, when the position of the mask main body is expressed in XY coordinates. “Near the diagonal ends” refers to a square region measuring 30 mm in the negative direction of the Y axis and 30 mm in the negative direction of the X axis from the diagonal ends, while “near the horizontal axis ends” refers to a square area measuring 30 mm in the negative direction of the X axis and 30 mm in the positive direction of the Y axis from the horizontal axis ends.

The present invention now will be described with reference to specific examples. For instance, with an 86-cm cathode ray tube with a 16:9 screen aspect ratio, the size of the effective surface 14 of the mask main body 17 in the example in FIG. 3 is such that the distance in the Y axis direction using the X axis as a reference (the half-width of the Y axis direction length) is roughly 200 mm, and the distance in the X axis direction using the Y axis as a reference (the half-width of the X axis direction length) is roughly 355 mm. In this case, the horizontal axis end is the position where X=355 mm and Y=0 mm, and the diagonal end is the position where X=355 mm and Y=200 mm. With this cathode ray tube, the radius of curvature of the panel outer surface is roughly 100,000 mm.

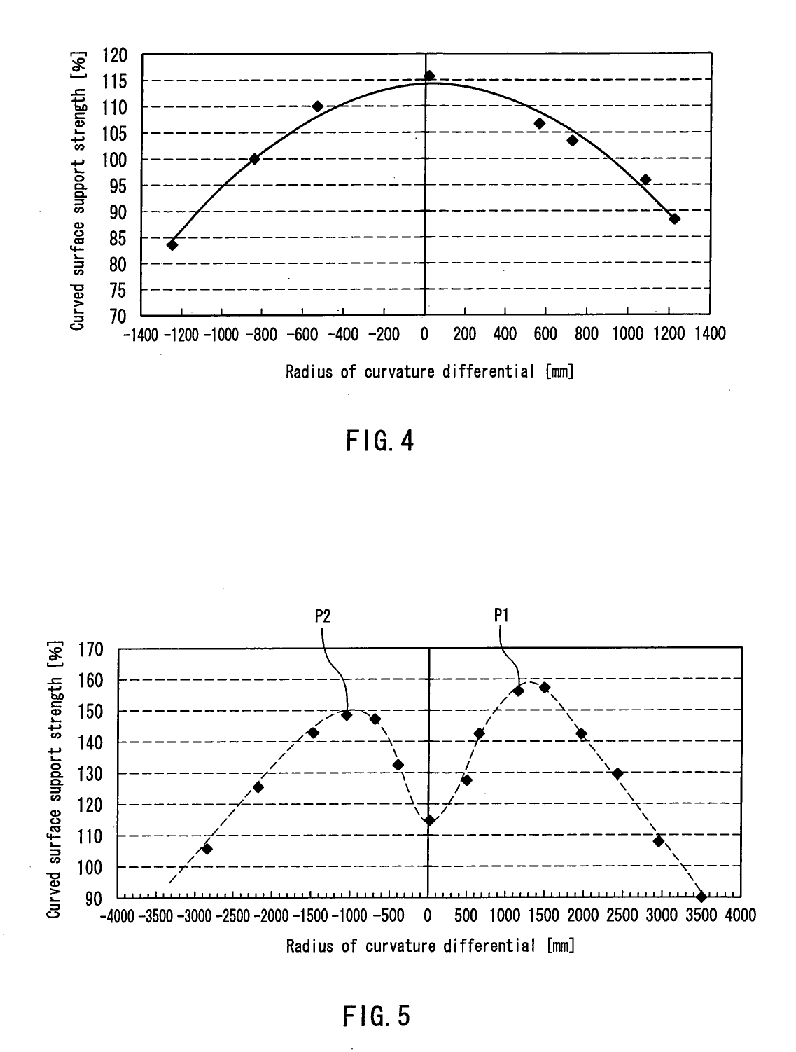

FIG. 4 is a graph of the relationship between the curved surface support strength of the shadow mask and Rk(h)−Rk(d) in Formula 5 above with an 86-cm cathode ray tube with a 16:9 screen aspect ratio. When we let the origin be the intersection of the X and Y axes in FIG. 3, the measurement position of Rk(h) is at X=350 mm and Y=0 mm, which is a position near the horizontal axis end of the effective surface 14, and the measurement position of Rk(d) is at X=350 mm and Y=200 mm, which is a position near the diagonal end. Rk(h)−Rk(d) is set so as to satisfy the above Formulas 3 and 4, and the mask main body used in this experiment has a dome-shaped curved surface when viewed as a whole.

The curved surface support strength on the vertical axis in FIG. 4 is at 100% when the drop strength in the tube axis direction on the neck side of the receiver tube is 10 G. The curved surface support strength is preferably such that a drop strength of at least 10 G (100%) can be ensured.

The experiment was conducted by changing the radius of curvature while varying amount of sink at the diagonal ends and keeping the sink constant at the horizontal axis and vertical axis ends of the effective surface 14. In this case, as the amount of sink at the diagonal ends increases, the radius of curvature at the diagonal ends decreases, and the greater is the absolute value of Rk(h)−Rk(d).

The curved surface support strength usually rises as the curved surface of the mask main body approaches being a spherical surface. Nevertheless, as we move closer to the ends on the horizontal axis in FIG. 4, the curved surface support strength decreases, so the curved surface support strength does not rise just because the sink at the diagonal ends is increased and the radius of curvature of the curved surface is reduced.

It can be seen from FIG. 4 that the curved surface support strength is highest when Rk(h)−Rk(d)=0, that is, when the radius of curvature Rk of the curved surface is equal near the horizontal axis ends and the diagonal ends. As the absolute value of Rk(h)−Rk(d) rises, the curved surface support strength decreases, but the target curved surface support strength (100%) will be attained as long as Rk(h)−Rk(d) is within ±800 mm. Specifically, it was found that adequate curved surface support strength of the shadow mask can be ensured by satisfying the above Formulas 3, 4, and 5.

Similar results are obtained when positions corresponding to Rk(h) and Rk(d) are selected within the above-mentioned square region that is 30 mm on one side, and the above Formulas 3, 4, and 5 are satisfied.

Although not depicted here, roughly the same phenomenon was confirmed when the amount of sink at the vertical axis ends and the diagonal ends was fixed and the sink at the horizontal axis ends was varied.

Experiments also were conducted to determine more effective conditions for increasing curved surface support strength. As a result, it was confirmed that the curved surface support strength can be increased further when the band-shaped range indicated by hatching in FIG. 3 includes a portion in which the radius of curvature distribution in the Y axis direction of the effective surface 14 becomes a concave radius of curvature distribution having a minimal value or a convex radius of curvature distribution having a maximal value, in addition to satisfying the above Formulas 3, 4, and 5.

More specifically, the hatched band-shaped range in FIG. 3 is one half (having the X axis as one side) of a band-shaped portion symmetrical around the X axis and with a width a of 30 mm in the Z axis direction from the X axis end of the effective surface 14.

FIG. 5 shows the experiment results, and is a graph of the relationship between the curved surface support strength and the radius of curvature differential in an 86-cm cathode ray tube with a screen aspect ratio of 16:9. The radius of curvature differential ΔRk on the horizontal axis of FIG. 5 is expressed by the following formula 6.
ΔRk=Rk(M)−(Rk(h)+Rk(d))/2 Formula 6

In Formula 6, Rk(M) is the radius of curvature of the curved surface at a middle position M, at which the radius of curvature exhibits a maximal or minimal value, between the area near the horizontal axis ends and the area near the diagonal ends of the effective surface 14. The measurement positions of Rk(h) and Rk(d) are the same as in FIG. 4, and the value of Rk(h)−Rk(d) was substantially zero.

Specifically, the experiment that gave the results in FIG. 5 shows the relationship between the curved surface support strength and the various values of the radius of curvature differential ΔRk, which changes when the amount of sink at the middle position M is varied, in a state in which the amount of sink at the diagonal ends and the horizontal axis ends of the effective surface 14 is held constant and the value of Rk(h)−Rk(d) is substantially zero.

Formula 6 expresses the difference between the largest value and the smallest value of the radius of curvature distribution in the Y axis direction of the band-shaped portion in FIG. 3, and (Rk(h)+Rk(d))/2 corresponds to the smallest value when Rk(M) is a maximal value, and to the largest value when Rk(M) is a minimal value. In the experiment that gave the results in FIG. 5, the value of Rk(h)−Rk(d) is substantially zero, so that the largest or smallest value was the average of Rk(h) and Rk(d).

Rk(M) at the middle position M is the maximal or minimal value of the radius of curvature of the curved surface within the range from near the horizontal axis ends to near the diagonal ends of the effective surface 14. Therefore, Rk(M) is a maximal value within the positive range (ΔRk>0) on the horizontal axis in FIG. 5. In this case, from near the horizontal axis ends to near the diagonal ends of the effective surface 14, there is a portion in which the radius of curvature distribution in the vertical axis direction is convex. Within the negative range (ΔRk<0), Rk(M) is a minimal value, and there is a portion in which the radius of curvature distribution in the vertical axis direction is concave.

As shown in FIG. 5, a curved surface support strength of 100% or higher could be ensured as long as the absolute value of ΔRk was within 3000 mm. The largest value for curved surface support strength was approximately 160%, which is far higher than the results in FIG. 4.

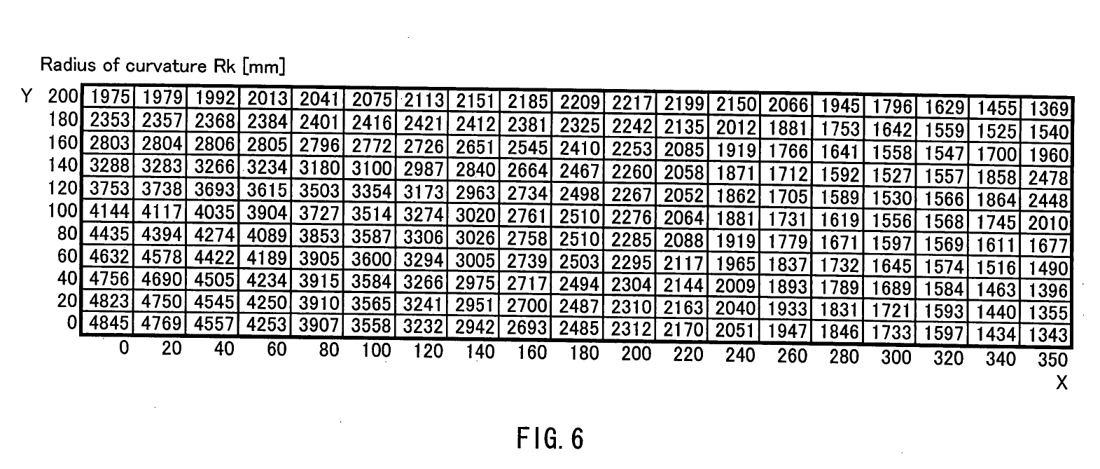

FIG. 6 shows the radius of curvature distribution for the example of the mask main body used in the experiment of FIG. 5. The example in FIG. 6 corresponds to P1 shown in FIG. 5, and it was confirmed in this experiment that the increase in curved surface support strength was about 57% higher than the target value.

In this embodiment, as shown in FIG. 6, the maximal value Rk(Max) of radius of curvature is 2478 mm, the radius of curvature Rk(h) at the horizontal ends is 1343 mm, the radius of curvature Rk(d) at the diagonal ends is 1369 mm, and the radius of curvature differential ΔRk at P1 is expressed by the following formula 6.
ΔRk=2478−(1343+1369)/2=1122 mm

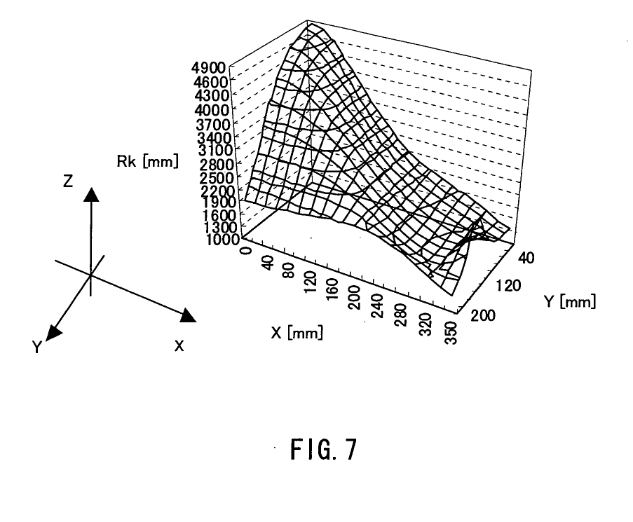

FIG. 7 is a three-dimensional graph of the data in FIG. 6, and allows us to ascertain the radius of curvature distribution for the entire curved surface. It also can be seen from this graph that the end of the effective surface in the horizontal direction (X axis direction; the portion on the right end in FIG. 7) is convex.

It can be seen from the results of the experiment in which the horizontal axis in FIG. 5 is the negative side that even when the radius of curvature distribution from near the horizontal axis ends to near the diagonal ends of the effective surface 14 is a concave radius of curvature distribution in which Rk(M) has a minimal value at the middle position M within the range of from near the horizontal axis ends to near the diagonal ends of the effective surface 14, the curved surface support strength is further increased, just as with a convex radius of curvature distribution.

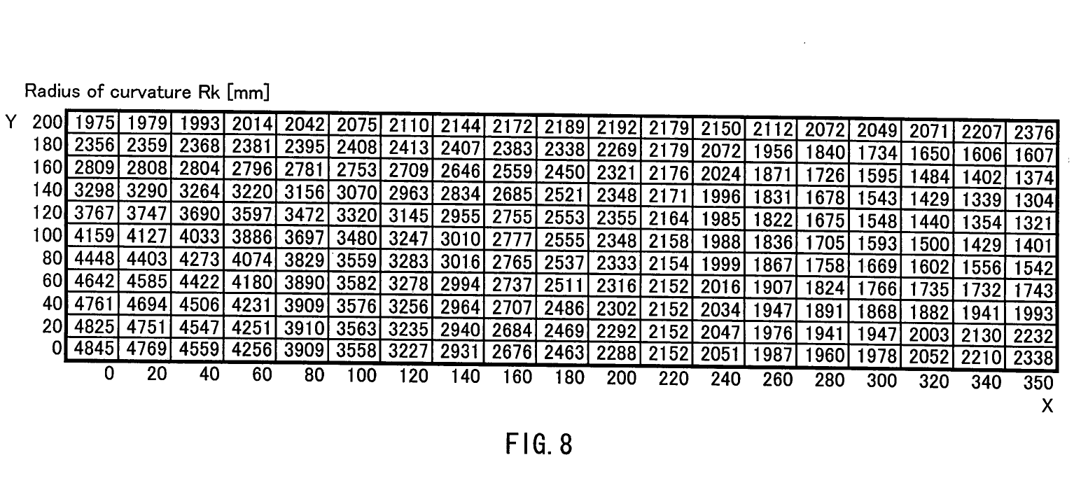

FIG. 8 is a table of the distribution of the radius of curvature in the example of the mask main body used for the experiment in FIG. 5. The example in FIG. 8 corresponds to P2 in FIG. 5, and it was confirmed that with this embodiment that the increase in curved surface support strength was about 50% higher than the target value.

In this embodiment, as shown in FIG. 8, the minimal value Rk(Min) of radius of curvature is 1304 mm, the radius of curvature Rk(h) at the horizontal ends is 2338 mm, the radius of curvature Rk(d) at the diagonal ends is 2376 mm, and the radius of curvature differential ΔRk at P2 is expressed as follows by the above Formula 6.
ΔRk=1304−(2338+2376)/2=−1053 mm

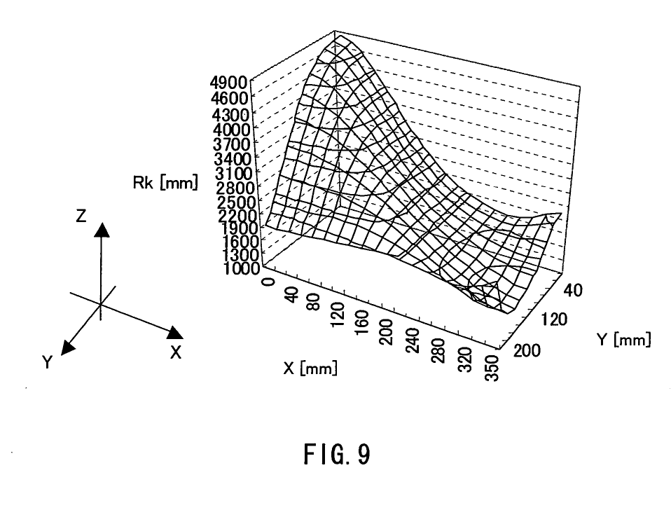

FIG. 9 is a three-dimensional graph of the data in FIG. 8, and allows us to ascertain the radius of curvature distribution for the entire curved surface. It also can be seen from this graph that the end of the effective surface in the horizontal direction (X axis direction; the portion on the right end in FIG. 9) is concave.

Thus, it was confirmed that the curved surface support strength can be further increased when the band-shaped range indicated by hatching in FIG. 3 includes a portion in which the radius of curvature distribution in the Y axis direction of the effective surface 14 becomes a concave radius of curvature distribution having a minimal value, or a convex radius of curvature distribution having a maximal value, in addition to satisfying the above Formulas 3, 4, and 5.

It is believed that this increase in the curved surface support strength is achieved because the stress applied during impact can be dispersed by forming the radius of curvature distribution of the curved surface on the short sides of the effective surface in an undulating shape. In this case, it is believed that the reason why the curved surface support strength decreases when the radius of curvature differential is too great as discussed above is stress accumulation caused by the undulations going up and down too far.

In the various embodiments given above, an example of a 86-cm cathode ray tube with a screen aspect ratio of 16:9 was described, but it was confirmed that the present invention is effective regardless of the screen size or the screen aspect ratio.

With the present invention, the curved surface support strength of the mask main body is raised, which reduces deviation in beam landing and prevents a decrease in color purity, and is therefore useful in television receivers and computer monitors, for example.

The embodiments given above are solely intended to clarify the technological content of the present invention, and the present invention is not limited to or by these specific examples alone. Various modifications are possible within the scope of the claims and the spirit of the invention, and the present invention should be interpreted broadly.

What is claimed is:

1. A cathode ray tube, comprising:
a panel on the inner surface of which a fluorescent screen is formed and the outer surface of which is substantially flat; and
a substantially rectangular shadow mask disposed across from the fluorescent screen,
wherein the shadow mask comprises a substantially rectangular mask main body attached to a substantially rectangular mask frame,
the mask main body includes an effective surface in which electron beam passage holes are formed, and a hole-free portion surrounding the effective surface, and
when the vertical axis is the axis in the screen vertical direction through which the tube axis of the cathode ray tube passes, and the horizontal axis be the axis in the screen horizontal direction through which the tube axis of the cathode ray tube passes,
and when Ry is the radius of curvature of a curve in the vertical axis direction of the effective surface of the mask main body, Rx is the radius of curvature of a curve in the horizontal axis direction, and calculate the radius of curvature Rk of the curved surface on the effective surface as Rk²=Rx ×Ry,
and when Rk(d) is the radius of curvature of the curved surface near the diagonal axis ends of the effective surface, Rk(h) is the radius of curvature of the curved surface near the horizontal axis ends, and Rk(c) is the radius of curvature of the curved surface in the center portion,
the following relations are satisfied:
Rk(c)>Rk(h),
Rk(c)>Rk(d), and
−800mm≦Rk(h)−Rk(d)≦800 mm

2. The cathode ray tube according to claim 1, wherein a band-shaped range of the effective surface, with a width of 30 mm, having the horizontal axis as one of its sides, and extending from the horizontal axis ends to the tube axis side, includes a portion in which the radius of curvature distribution in the vertical axis direction of the effective surface becomes a concave radius of curvature distribution having a minimal value.

3. The cathode ray tube according to claim 2, wherein, in the band-shaped range of the effective surface with a width of 30 mm, having the horizontal axis as one of its sides, and extending from the horizontal axis ends to the tube axis side, the absolute value of the difference between a largest value and a smallest value of the radius of curvature of the effective surface is 3000 mm or less.

4. The cathode ray tube according to claim 1, wherein a band-shaped range of the effective surface, with a width of 30 mm, having the horizontal axis as one of its sides, and extending from the horizontal axis ends to the tube axis side, includes a portion in which the radius of curvature distribution in the vertical axis direction of the effective surface becomes a convex radius of curvature distribution having a maximal value.

5. The cathode ray tube according to claim 4, wherein, in the band-shaped range of the effective surface with a width of 30 mm, having the horizontal axis as one of its sides, and extending from the horizontal axis ends to the tube axis side, the absolute value of the difference between a largest value and a smallest value of the radius of curvature of the effective surface is 3000 mm or less.
